(19) United States
(12) Patent Application Publication
(10) Pub. No.: US 2025/0343254 A1
(43) Pub. Date: Nov. 6, 2025

(54) ELECTROCHEMICAL ASSEMBLY

(71) Applicant: TTP PLC, Melbourn, Royston Hertfordshire (GB)

(72) Inventors: Jamie DAVIDSON, Melbourn (GB); Charles COOKE, Melbourn (GB); Frederic SCOTT, Melbourn (GB); Michael Blane SCOTT, Melbourn (GB); Oliver NORTH, Melbourn (GB); Ewan LAIDLAW, Melbourn (GB); Ella INWALD, Melbourn (GB)

(21) Appl. No.: 18/870,982

(22) PCT Filed: May 30, 2023
(86) PCT No.: PCT/GB2023/051426

§ 371 Date: Dec. 2, 2024

(30) Foreign Application Priority Data
May 30, 2022 (GB) 2207991.7

(51) Int. Cl. H01M 8/248; C25B 9/05; C25B 9/21; C25B 9/23; C25B 9/60; C25B 9/77; C25B 15/08; H01M 8/10; H01M 8/1004; H01M 8/2475; H01M 8/2483; H01M 8/2484

(52) U.S. Cl. CPC H01M 8/248; C25B 9/05; C25B 9/21; C25B 9/23; C25B 9/60; C25B 9/77; C25B 15/08; H01M 8/1004; H01M 8/2475; H01M 8/2483; H01M 8/2484; H01M 2008/1095

(57) ABSTRACT

An electrochemical assembly, comprising: a plurality of electrochemical cells arranged to form an electrochemical stack having a first end and a second end; a first endcap disposed at the first end of the electrochemical stack, and a second endcap disposed at the second end of the electrochemical stack, and at least one of the endcaps being arranged to provide a fluidic connection to the electrochemical stack; wherein the first and second endcaps are secured to the electrochemical stack by a fibre-reinforced casing that extends around at least a portion of the electrochemical stack and at least a portion of each endcap such that a fluidic seal is formed between the electrochemical stack and each endcap.

### FIELD OF THE INVENTION

The present invention relates to an electrochemical assembly comprising an electrochemical stack, which may be used for electrolysis for production of hydrogen gas, and a method of manufacture thereof.

### BACKGROUND

A desired energy transition away from fossil fuels will require large volumes of hydrogen to be produced using renewable electricity. Hydrogen is used for a combination of vehicles, energy storage and chemical processes, and so there is an increasing need for efficient and reliable ways to produce large quantities of hydrogen. Hydrogen may be produced by the electrolysis of water, where electrical energy allows water molecules to be split into hydrogen and oxygen molecules. This may be achieved in a number of ways, such as by alkaline electrolysis, solid oxide electrolysis, or Proton Exchange Membrane (PEM) electrolysis. Electrolysis uses electrical and/or thermal energy to split water molecules into hydrogen and oxygen. Conversely, fuel cells may be used to convert hydrogen and oxygen into water thereby producing electrical energy.

Typically, an electrochemical unit (or “assembly”) will comprise a large number of smaller “cells” that each operate using the electrolysis or fuel cell process described above. The cells are stacked vertically on top of each other to create a “stack”, thus making each “layer” of the stack a single cell. Channels run through the stack and through the layers to transfer fluid (H₂O, H₂, O₂, and electrolyte) to and from the cells. Multiple stacks may be operated simultaneously in order to meet the required output demands. Once produced, for some applications, for example automotive, the hydrogen needs to be stored under very high pressure (>700 bar) in order to keep the volume of the storage tanks at a reasonable size, typically around 60 litres.

However, electrochemical units such as those described above have a number of limitations. Firstly, traditional electrolyser units operate at around 35 bar and have no pressure containment other than the stack itself. In order to provide additional pressure containment, it is not commercially and technically feasible to run steel pressure vessels at much higher pressure (e.g. above 100 bar) due to the limited tensile strength of steel. In fact, due to safety and cost concerns, the conventional wisdom in the industry is to try and reduce the pressure of the vessel. Especially due to safety concerns with pressurised oxygen at the anode, often only the hydrogen generating cathode of the electrolyser is pressurised. As a result, the maximum differential pressure is limited in order to avoid mechanical failure of the membrane or unsafe hydrogen cross-over to the anode. Therefore, the maximum output pressure of hydrogen is limited, and additional compressors are needed to pressurize the hydrogen for storage. The hydrogen compressor contributes to about 30% of the system cost in typical electrolysers, and also reduces the overall energy efficiency of the system.

A further problem of traditional electrochemical units is that the size and shape of a cell defines the size and shape of the layers in the stack, which restricts the options for the shape and size of the stack. Cells are usually a substantially square shape so that liquid and gas may be conveniently exchanged with inlets and outlets along the sides of the cell. Since the power of a cell is proportional to its area, stacks are limited to having a square cross-section in order to avoid wasting space. Furthermore, when the size of cells becomes large, the fluid is not supplied consistently to all areas of the cell, thereby reducing the efficiency. Conventional attempts to address this problem can require the addition of channels to plates in the stack, which may increase the cost substantially.

It is an object of the present invention to overcome all of the above-mentioned issues inherent in existing electrochemical units.

### SUMMARY OF INVENTION

According to a first aspect of the present invention there is provided an electrochemical assembly, comprising: a plurality of electrochemical cells arranged to form an electrochemical stack having a first end and a second end; a first endcap disposed at the first end of the electrochemical stack, and a second endcap disposed at the second end of the electrochemical stack, and at least one of the endcaps being arranged to provide a fluidic connection to the electrochemical stack; wherein the first and second endcaps are secured to the electrochemical stack by a fibre-reinforced casing that extends around at least a portion of the electrochemical stack and at least a portion of each endcap such that a fluidic seal is formed between the electrochemical stack and each endcap.

As used herein, the term “electrochemical” refers to any process involving chemical changes interacting with electrical potential. This includes electrolysis, where an electrical potential is used to induce a chemical reaction. This also includes electrochemical reactions that produce electrical potential, such as in electrochemical fuel cells.

Advantageously, the fibre-reinforced casing may provide both longitudinal compression to the ends of the stack as well as radial compression to the sides of the stack. As used herein, the term “longitudinal” preferably refers to a direction (or axis) extending between the first and second ends of the stack. The term “radial” preferably refers to a direction that is perpendicular to the longitudinal direction.

Preferably, the fibre-reinforced casing is a unitary (e.g., monocoque) casing. In this way, separate components such as frames or supports are not required in order to provide compression of the stack. Furthermore, the unitary casing means that there are no connection points between separate components where failures typically occur, thereby reducing the overall chance of failure.

Preferably, the fibre-reinforced casing is arranged to support (or reinforce) the sides of the stack and both of the endcaps (i.e. to avoid substantial gaps between the fibre-reinforced casing and the stack). Optionally, the fibre-reinforced casing is arranged to directly contact the stack and both of the endcaps. Alternatively, one or more additional layers may be provided between the fibre-reinforced casing and the stack, such as a film or tape layer (e.g., Kapton®). Such additional layers may prevent conduction through the fibre-reinforced casing, and/or may reduce pressure on the casing due to sharp edges of the stack or the endcaps.

The casing may be arranged to surround substantially all of the electrochemical stack and substantially all of each endcap. A portion of each endcap is preferably not surrounded by the casing, so that any fluid ports and/or electrical terminals that are located on the endcaps are not obscured. By arranging the casing to extend around at least a portion (and preferably substantially all) of the endcaps, the casing may provide longitudinal containment and compression to the stack, since the stack may contact an interior surface of the casing that faces (at least partially) in the longitudinal direction. By contrast, where only a cylindrical casing is used to cover the sides of the stack, only minimal longitudinal compression is provided, which means additional structures may be required to compress the ends. This allows the electrochemical assembly to operate at a higher pressure (e.g., compared to a stack where metal casings or frames are used, which cannot typically withstand the increased longitudinal stresses at higher pressure).

For example, “type 3” pressure vessels, which typically feature a metal (e.g. thin aluminium) liner, fully overwrapped with carbon composite, may be filled to pressures of up to 300 bar; and “type 4” pressure vessels, typically made primarily from carbon composite with a polymer liner, can be filled to pressures above 700 bar. The terms “type 3” and “type 4” pressure vessels have their common meaning in the field of art, and will be well-understood by a person of skill in the art.

The first and second endcaps may be configured as fluid distribution manifolds for facilitating internal fluid flow through the electrochemical stack.

At least one of the endcaps may comprise one or more fluid ports arranged to transmit fluid therethrough, thereby to provide a fluid connection to the electrochemical stack. In one embodiment, the fluid ports may be configured to contain pressurised fluid, for example at least one of the fluid ports may be configured to transmit or convey fluid at a pressure of at least 200 bar, and preferably at least 500 bar. One of the endcaps may comprise all of the fluid ports (for example, four fluid ports on one endcap). Alternatively, the fluid ports may be distributed between both endcaps (for example, two fluid ports on each endcap).

At least one of the endcaps may be configured to provide at least one electrical connection to the electrochemical stack.

In one embodiment, one of the endcaps is configured to provide a first terminal for electrical connection to the plurality of electrochemical cells, and the other of the endcaps is configured to provide a second terminal for electrical connection to the plurality of electrochemical cells, wherein the first and second terminals are arranged to facilitate a voltage across the electrochemical stack.

In another embodiment, one of the endcaps may comprise a first portion configured to provide a first terminal for electrical connection to the plurality of electrochemical cells, and a second portion configured to provide a second terminal for electrical connection to the plurality of electrochemical cells.

When the electrochemical assembly is configured as an electrolyser assembly, a voltage may be applied between the first and second terminals by an electrical supply. When the electrochemical assembly is configured as a fuel cell, the first and second terminals may instead produce a voltage therebetween.

Preferably, at least one of the endcaps has a generally domed, preferably hemi-spherical, configuration, and more preferably each of the endcaps has said configuration. In this way, the fibre reinforced casing may continuously transition from the sides of the stack over the endcap(s); this distributes the longitudinal compression force over the interior surface of the casing, and reduces the maximum pressure applied to the casing (e.g., due to bending around sharp edges of the stack or endcaps).

The fibre-reinforced casing may comprise at least one of carbon fibre, glass fibre or aramid fibre, preferably wherein the fibre is impregnated into a polymer matrix.

At least one of the endcaps may comprise a compression device (e.g. a resilient means) arranged to apply a compressive force to the plurality of electrochemical cells forming the electrochemical stack when secured thereto, with the compressive force being applied in a longitudinal direction between the endcaps. The resilient means may comprise a resilient element, preferably a coiled spring element. Alternatively, the compression device may comprise a piston (or a “linear actuator”), which may be electrically-powered or hydraulically-powered, for example.

Since the compression device may engage with the interior surface of the fibre-reinforced casing in order to provide compression to the stack, the resilient means may be pre-compressed during wrapping and curing, and then released after curing to allow the resilient means to engage the interior surface of the casing. Such an approach would not typically be attempted since the endcaps (where pre-compression would be applied) would already be substantially covered by the fibre-reinforced material. Furthermore, the combination of a compression device with a fibre-reinforced casing may not appear feasible since the heat required for curing of the fibre-reinforced material may affect performance of the compression device. To provide the compression, a mandrel may be used that both rotates the stack and endcaps during wrapping, preferably while applying a force to the endcaps.

Optionally, the force applied by the compression device may be adjustable. In this way, the longitudinal compression force applied to the stack can varied, including after the electrochemical assembly is fully assembled. For example, a portion of the endcap that is not surrounded by the casing (e.g., an opening) may allow access to the compression device for adjustment. Where the compression device is a coiled spring element, a bolt may be used to tighten the coiled spring element, where the bolt may be accessible through an opening in the casing. Alternatively, pressure of the piston may be altered to adjust the amount of longitudinal compression.

In one embodiment, the electrochemical stack comprises: a plurality of layers, each layer electrically connected with an adjacent layer; wherein each layer comprises a plurality of electrochemical cells. In another embodiment, each layer may alternatively comprise a single cell connected in series with a corresponding cell in an adjacent layer.

According to a second aspect of the present invention there is provided an electrochemical assembly, comprising: an electrochemical stack, comprising: a plurality of layers, each layer electrically connected with an adjacent layer; wherein each layer comprises a plurality of electrochemical cells.

The following optional aspects may apply to the electrochemical assembly of either the first or second aspect (or both).

Adjacent layers in the electrochemical stack may be electrically connected to each other in series. Preferably, each of the plurality of layers and/or the plurality of electrochemical cells are substantially flat or planar. This allows the layers to be stacked directly upon each other without gaps, thereby improving the space-efficiency of the electrochemical assembly. Furthermore, this allows layers to be simply added or removed at ends of the stack to vary the output of the electrochemical assembly; since the flat layers are easily stackable, such a change is relatively simple to make (e.g., compared to changing a width of the stack to adjust the output). In other words, the electrochemical assembly is modular.

The plurality of electrochemical cells in each layer may be electrically connected together in parallel. In this case, within each layer, the plurality of electrochemical cells are preferably directly connected to each other in parallel. This may be achieved using at least one bipolar plate that provides a common electrode to all the electrochemical cells within each individual layer. In this way, the electrochemical cells within each layer may remain electrically in parallel regardless of the length of the stack or the electrical connections made via the endcaps. The at least one bipolar plate is preferably substantially flat, thereby facilitating stacking. The at least one bipolar plate may be relatively thin (e.g., thickness is not required to form 3D structures such as grooves or channels), thereby reducing weight of the stack.

The (substantially flat) electrochemical cells are preferably substantially rectangular, more preferably substantially square shaped. The plurality of electrochemical cells on each layer of the electrochemical stack may be arranged in a (e.g. regular) grid configuration. In this way, a greater proportion of the area of each layer may be used to provide electrochemical cells (e.g., where each layer is circular to provide a cylindrical stack). Furthermore, where a plurality of smaller cells are used (rather than one large cell in each layer), the supply of fluid is more uniform across each of the cells.

In an alternative embodiment, the plurality of electrochemical cells in each layer may not be directly electrically connected to each other. For example, the electrochemical stack may comprise a plurality of sub-stacks, with each sub-stack containing a plurality of layers each having one or more electrochemical cells. The sub-stacks as a whole may be electrically connected in parallel without the layers of each sub-stack being electrically connected in parallel.

The plurality of layers may be further configured to provide a plurality of fluid inlet channels and a plurality of fluid outlet channels within the electrochemical stack, the inlet channels and outlet channels arranged to transmit fluid to and from each layer of the electrochemical stack, whereby and further to transmit fluid across each electrochemical cell in each layer.

Each electrochemical cell within each layer of the electrochemical stack may be arranged to have fluid transmitted across it via at least one fluid inlet channel and at least one fluid outlet channel that together form a subset of the plurality of fluid inlet channels and fluid outlet channels that are arranged to transmit fluid to and from that layer.

In one embodiment multiple subsets of fluid inlet channels and fluid outlet channels may be arranged to extend through the electrochemical stack, preferably wherein the multiple subsets of fluid inlet channels and fluid outlet channels corresponding to each electrochemical cell within each layer of the electrochemical stack are different to each other, and more preferably wherein the multiple subsets of fluid inlet channels and fluid outlet channels are mutually exclusive to each other.

The plurality of fluid inlet channels and fluid outlet channels may be arranged to extend between the endcaps through the electrochemical stack (e.g. in the longitudinal direction), such that adjacent electrochemical cells within adjacent layers of the electrochemical stack are supplied by the same subset of fluid inlet channels and fluid outlet channels.

Each subset of fluid inlet channels and fluid outlet channels may comprise: a first fluid inlet channel and a first fluid outlet channel together arranged to transmit fluid across one or more electrochemical cells in a first direction; and a second fluid inlet channel and a second fluid outlet channel together arranged to transmit fluid across one or more of the electrochemical cells in a second direction, which is different to the first direction.

The first fluid inlet channel may be arranged to be substantially opposite to the first fluid outlet channel, and the second fluid inlet channel is arranged to be substantially opposite to the second fluid outlet channel.

Each layer of the electrochemical stack may comprise: a first plate and a second plate arranged in an opposed configuration, each plate providing a respective electrode for each of the plurality of electrochemical cells on the layer; a partially-permeable membrane for the transmission of ions disposed between the first plate and the second plate; a first porous transport layer, arranged to allow a first fluid to flow in a first direction, disposed between the first plate and the membrane; and a second porous transport layer, arranged to allowing a second fluid to flow in a second direction, disposed between the second plate and the membrane.

In one embodiment, the first and second directions are different directions, preferably orthogonal directions. However, in another embodiment, the first and second directions may be substantially the same.

The first plate and the second plate are preferably thin metal plates, preferably with surfaces that are substantially flat or smooth (e.g. without etched channels or grooves). The metal plates preferably have a thickness that is between about 10 μm to about 1000 μm thick, more preferably between about 100 μm to about 500 μm thick. For example, the plates may be 0.5 mm thick. The metal plates may be provided by foil. In this way, the plates provide a conductive layer that is substantially impervious to water.

The first plate and the second plate may be separated by an electrically insulating spacer disposed between the first and second plates.

Advantageously, since the stack is mostly formed from thin metal plates and insulating materials such as plastic, the stack can be very light. By contrast, existing electrochemical assemblies may use solid metal with etched 3D channels and grooves, which results in a heavy stack that is more expensive and more time consuming to manufacture. By providing a more lightweight stack, the stages of manufacturing may be simplified (e.g., holding the stack in a mandrel during a wrapping process is easier, especially if held horizontally) and the completed electrochemical assembly may be transported more easily. Furthermore, the materials are relatively cheap, and do not require etching or other substantial modification before assembly.

The electrochemical stack may be substantially cylindrical. Advantageously, cylindrical stacks are more able to withstand radial pressure from the pressurized fluids contained therein. Furthermore, due to the rotational symmetry, cylindrical stacks may be wrapped more easily to provide a fibre-reinforced casing. Where a cylindrical stack is used, by providing a plurality of cells in each layer, the (substantially square) cells may more efficiently fill the area of each layer (as compared to having only a single square cell on each layer).

In one embodiment, each cell within each layer may comprise a plurality of apertures in the first plate and the second plate, thereby providing each subset of fluid inlet and fluid outlet channels. Each of the apertures may be a, preferably elongate, slot that extends along a length of a side of each cell. Each plate may comprise a gasket structure configured to direct fluid across each of the cells from one of the inlet channels to a corresponding outlet channel.

The electrochemical assembly may be configured as an electrolyser assembly, preferably a hydrogen electrolyser for electrolysing H₂O to form H₂ and O₂. Alternatively, the electrochemical assembly may be configured as a fuel cell, preferably a hydrogen fuel cell for generating electrical energy from H₂ and O₂.

According to another aspect of the present invention, there is provided a plate for forming part of a layer in an electrochemical stack for an electrochemical assembly, the plate comprising: a plurality of defined regions, each defined region arranged to provide an electrode of an electrochemical cell in the layer formed by the plate, and a plurality of apertures in the plate, each aperture arranged adjacent a defined region such that each defined region has at least two adjacent apertures, wherein each aperture is configured to define, when the plate is combined with another such plate to form one of a plurality of layers within the electrochemical stack, part of either a fluid inlet channel or a fluid outlet channel that are together configured to transmit fluid across the electrode of the electrochemical cell provided by the defined region.

Ideally, the plate is substantially flat or planar, thereby facilitating forming (the formation of) apertures in the plate, and stacking of plates to form layers of an electrochemical stack.

In one embodiment, the at least two apertures adjacent each defined region may comprise a fluid inlet channel and a fluid outlet channel, preferably which together form a subset of fluid inlet and fluid outlet channels that transmit fluid across one or more electrodes corresponding to one or more electrochemical cells in the electrochemical stack, and more preferably wherein the subsets of fluid inlet and fluid outlet channels corresponding to each defined region are different to each other, and even more preferably mutually exclusive to each other.

The defined regions may be substantially rectangular, and preferably substantially square shaped, and each aperture is a slot that extends along a length of a side of each defined region.

The plate may further comprise a gasket structure arranged to constrain the transmission of fluid across the defined region from the fluid inlet channel to a corresponding fluid outlet channel.

The at least two apertures may be arranged adjacent the defined region in a substantially opposed configuration. In one embodiment, the defined regions on the plate are arranged in a grid. The plate may be substantially circular.

According to another aspect of the present invention, there is provided a method of manufacturing an electrochemical assembly, comprising: arranging a plurality of layers of electrochemical cells to form an electrochemical stack having a first end and a second end; positioning a first endcap at the first end of the stack, and a second endcap at the second end of the stack, with at least one of the first or second endcaps being arranged to provide a fluidic connection to the electrochemical stack; wrapping a fibre-reinforced material around the electrochemical stack to form a layer that covers at least a portion of the electrochemical stack and at least a portion of each endcap whereby to secure both of the endcaps to the stack such that the endcaps are fluidly sealed with the electrochemical stack; and curing the fibre-reinforced material through the application of heat to form a fibre-reinforced casing.

The method may further comprise wrapping the fibre-reinforced material around the electrochemical stack and endcaps is performed by mounting them to a rotatable mandrel configured to apply a compressive force to the plurality of electrochemical cells forming the electrochemical stack during wrapping. Optionally, the method may comprise adjusting a compression device in at least one of the endcaps, after curing the fibre-reinforced material to form a fibre-reinforced casing. In this way, a compressive force applied to the layers of the stack may be adjusted.

Preferably, the fibre-reinforced material is provided as a single (continuous) strip, though it will be appreciated that several pieces of fibre-reinforced material (e.g., separate strips) may be wrapped around the stack (either sequentially or simultaneously from separate spools), provided that the fibre-reinforced material is wrapped and cured to form a unitary casing. The strips of fibre-reinforced material may be spirally wrapped. The strips may be wrapped with several overlapping layers in order to provide a fibre-reinforced casing with any suitable thickness. The fibre-reinforced material may be wrapped directly against the stack (i.e., to avoid substantial gaps between the fibre-reinforced casing and the stack).

It will be understood by a skilled person that any apparatus feature described herein may be provided as a method feature, and vice versa. It will also be understood that particular combinations of the various features described and defined in any aspects described herein can be implemented and/or supplied and/or used separately.

Moreover, it will be understood that the present invention is described herein purely by way of example, and modification of detail can be made within the scope of the invention. Furthermore, as used herein, any “means plus function” features may be expressed alternatively in terms of their corresponding structure.

### BRIEF DESCRIPTION OF DRAWINGS

At least one embodiment will now be described, purely by way of example, with reference to the accompanying figures, in which:

FIG. 1 shows a schematic diagram of an electrolytic cell;

FIGS. 2A to 2D show an embodiment of an electrochemical assembly according to the present invention;

FIGS. 3A to 3C show schematically different stages of a method of manufacturing the electrochemical assembly of FIGS. 2A to 2C;

FIG. 4A shows schematically a typical electrochemical stack;

FIGS. 4B and 4C show schematic embodiments of an electrochemical stack according to the present invention, where the stack is formed from a plurality of layers each having a plurality of electrochemical cells;

FIG. 5 shows schematically the electrochemical stack depicted in FIG. 4B, a close-up of one of the electrochemical cells of the stack, and a cross section through part of that cell;

FIG. 6A shows a schematic embodiment of a plate that may form part of the electrochemical stack having a plurality of defined regions, each with adjacent apertures;

FIG. 6B shows a schematic plan view of a defined region on the plate that may form part of an electrochemical cell, with adjacent apertures;

FIGS. 7A to 7C show schematically a layer of the electrochemical stack formed from a pair of the plates shown in FIG. 6A; and

FIGS. 8A and 8B show schematically cross-sectional views through an electrochemical stack formed from a plurality of the plates and layers shown in FIGS. 6 and 7.

### DETAILED DESCRIPTION

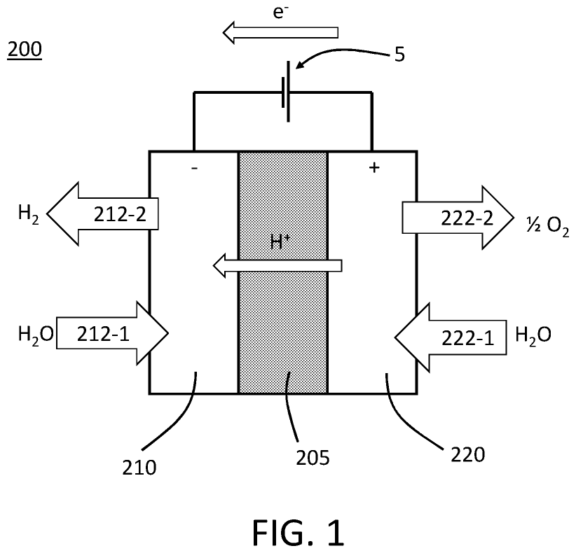

FIG. 1 shows a schematic diagram of a single electrochemical cell (“cell”) 200, which in an embodiment may be an electrolytic cell 200 for carrying out Proton Exchange Membrane (PEM) electrolysis in which water (H₂O) may be converted into hydrogen (H₂) and oxygen (O₂.). It will of course be appreciated that the embodiments described herein may be used for other types of electrolysis, such as Anion Exchange Membrane (AEM) electrolysis, Alkaline Water Electrolysis (AWE) or solid oxide electrolysis, and that other electrolysis reactions with other substances may be performed.

Moreover, the embodiments described herein may be used to provide a fuel cell, for example a hydrogen fuel cell. In a hydrogen fuel cell, hydrogen and oxygen are instead provided as inputs and are combined to produce both water and electrical power as outputs. It will be appreciated that a fuel cell may operate using other substances. Therefore, as used herein, the term “electrochemical” refers to any process where chemical changes interact with electric potential (“voltage”), which includes both electrolysis and fuel cell reactions.

In FIG. 1, the cell 200 comprises a negatively charged cathode 210 and a positively charged anode 220 separated by a membrane 205. A power supply 5 provides a potential difference between the cathode 210 and the anode 220. The anode 220 is supplied with water from a fluid inlet 222-1, which is oxidised in the following half reaction:

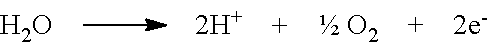

The membrane 205 is selectively permeable to the H⁺ ions (protons), and due to the positive charge of the anode 220, the protons are conducted through the membrane 205 into the cathode 210. The electrons produced in the half reaction are also supplied to the cathode 210 by the power supply 5. The gaseous oxygen gas produced in the reaction is transported out of the anode 220 of the cell 200 by a fluid outlet 222-2. In the cathode 210, the protons and electrons combine to form hydrogen gas in the following half reaction:

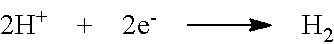

The hydrogen gas is transported out of the cathode 210 of the cell 200 with a fluid outlet 212-2. A fluid inlet 212-1 supplies H₂O to the cathode 210. Providing the minimum amount of energy is supplied by the power supply 5 and optionally from an external heat source (not shown), the following overall reaction occurs:

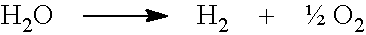

Ideally, thousands of the cells 200 described above will be stacked together in series to form an electrolyser stack 10, with each layer 100 of the stack 10 containing one cell 200. The power supply 5 provides a voltage between the ends of the stack 10, thereby providing the necessary voltage to each of the cells 200 within the stack 10. In other words, the cells 200 in the stack 10 are electrically connected in series.

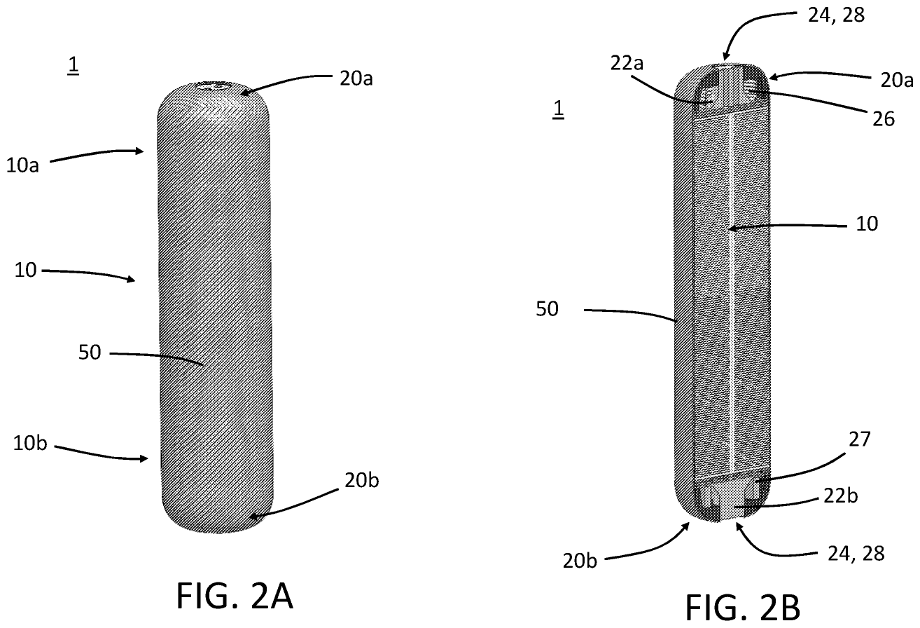

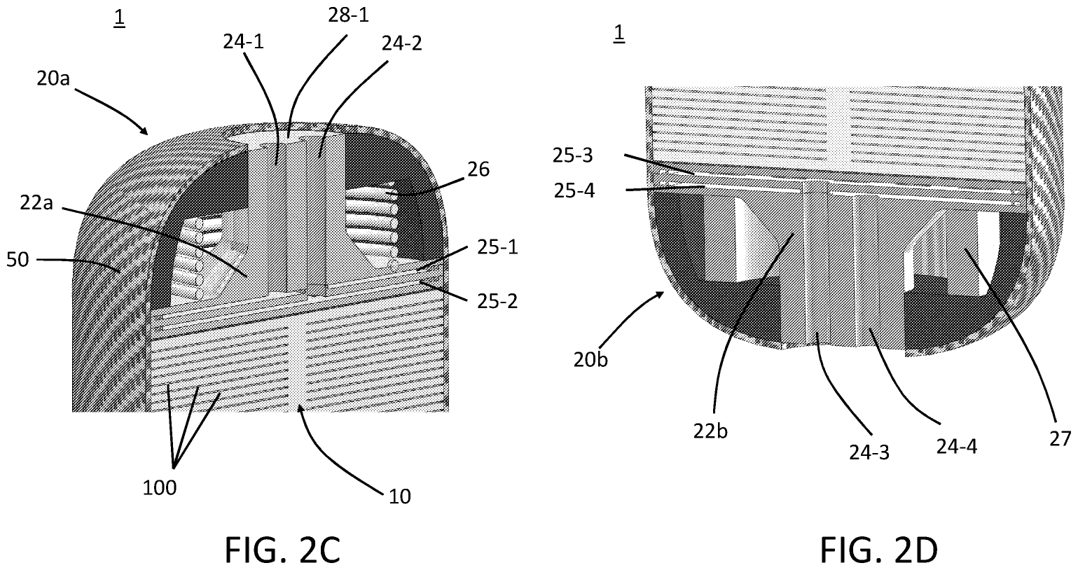

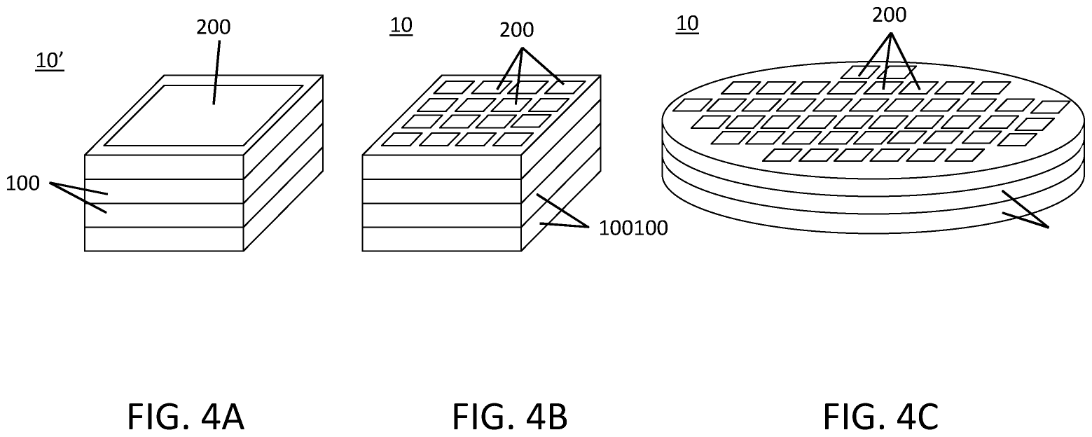

An embodiment of an electrochemical assembly 1 will now be described with reference to FIGS. 2A to 2D. The electrochemical assembly 1 comprises an electrochemical stack 10 with a plurality of layers 100 (only some labelled). Each of the layers 100 may comprise a single electrochemical cell 200, or as will be described in more detail in relation to FIGS. 4 to 8, may comprise a plurality of electrochemical cells 200. The stack 10 has a longitudinal axis with a first end 10a and a second end 10b. The stack 10 is substantially cylindrical along the longitudinal axis. Disposed on the first end 10a of the stack 10 is a first endcap 20a. Disposed on the second end 10b of the stack 10 is a second endcap 20b. The endcaps 20a, 20b may be made of steel, preferably stainless steel, or can be made from any material with appropriate mechanical strength and chemical compatibility, such as aluminium or an engineering plastic.

At least one of the endcaps 20a, 20b is arranged to provide a fluidic connection to the stack 10 such as through one or more fluid ports 24. The term “fluid” can refer to any liquid or gas, which includes any electrolytes required for the electrolysis or fuel cell reaction. For example, liquid water and gaseous hydrogen and oxygen are fluids that may pass through the fluid ports 24. In this embodiment, the first endcap 20a comprises a first fluid port 24-1 and a second fluid port 24-2, as shown in FIG. 2C. The fluid ports 24-1, 24-2 may connect to a first fluid distribution manifold 22a in the first end cap 20a. More specifically, the first fluid port 24-1 connects to a first fluid distribution layer 25-1, and the second fluid port 24-2 connects to a second fluid distribution layer 25-2. The second endcap 20b comprises a third fluid port 24-3 and a fourth fluid port 24-4, as shown in FIG. 2D. These fluid ports 24-3, 24-4 are arranged on the second endcap 20b in a direction that is preferably perpendicular to the fluid ports 24-1, 24-2 on the first endcap 20a, and thus are not visible in the cross-section in FIG. 2B. The fluid ports 24-3, 24-4 may connect to a second fluid distribution manifold 22b in the second endcap 20b. More specifically, the third fluid port 24-3 connects to a third fluid distribution layer 25-3, and the fourth fluid port 24-4 connects to a fourth fluid distribution layer 25-4.

The fluid distribution layers 25 distribute fluid through a plurality of channels (not shown) that connect to the cells 200 within the stack 10. One possible configuration of these channels will be described in detail in relation to FIGS. 4 to 8, but any suitable configuration of channels may be used in order to transport fluid to and from the cells 200. For example, the fluid ports 24-1, 24-2 on the first endcap 20a may provide fluid inlets and outlets to the anode 220 of each cell 200, and the fluid ports 24-3, 24-4 on the second endcap 20b may provide fluid inlets and outlets to the cathode 210 of each cell 200 (or vice versa). Advantageously, this may simplify the structure of internal fluid channels in the electrochemical assembly 1, since only two fluid distribution layers 25 need to be located at each end of the stack 10a, 10b. Alternatively, all four of the fluid ports 24 and fluid distribution layers 25 may be located on one of the endcaps 20a, 20b. This may simplify external fluid management, since fluid connections only need to be made to one end of the electrochemical assembly 1. It will be appreciated that more or fewer fluid ports 24 and/or fluid distribution layers 25 may be included depending on the required number of inputs or outputs to the electrochemical assembly 1. The fluid ports 24 may be located on either or both of the endcaps 20a, 20b in a standard arrangement to facilitate connection with external fluid containers.

The endcaps 20a, 20b may also include electrical terminals 28-1, 28-2 for facilitating a voltage (potential difference) across the stack 10. When configured as an electrolyser stack 10, an external voltage may be applied to the electrical terminals 28-1, 28-2 of the stack 10. Conversely, when configured as a fuel cell stack, the electrical terminals 28-1, 28-2 are used to provide an output voltage. In this embodiment, the first endcap 20a may be used to provide the first electrical terminal 28-1, and the second endcap 20b may be used to provide the second electrical terminal 28-2. Advantageously, providing the electrical terminals 28-1, 28-2 on opposite ends of the electrochemical assembly 1 reduces the complexity of internal electrical connections to the stack 10. Alternatively, both electrical terminals 28-1, 28-2 may be provided at one of the endcaps 20a, 20b; in this arrangement a first portion (not shown) of one of the endcaps 20a, 20b may provide the first electrical terminal 28-1, and a second portion (not shown) of the same endcap 20a, 20b may provide the second electrical terminal 28-2, where the first portion and second portion of the endcap 20a, 20b are electrically insulated from each other. Advantageously, providing the electrical terminals 28-1, 28-2 at one end of the electrochemical assembly 1 may simplify external electrical connections.

In order to prevent separation of the layers 100 of the stack 10, particularly during pressurized operation, it is important to provide containment of the stack 10 in the longitudinal direction. Typically, this may be achieved by connecting the first endcap 20a (or endplate) to the second endcap 20b (or endplate) by a plurality of bolts. These bolts may then be tightened to hold the layers 100 together. However, this configuration is not suitable for high pressure operation; due to the limited tensile strength of steel, the increased force may be sufficient to snap the bolts or other metal connections.

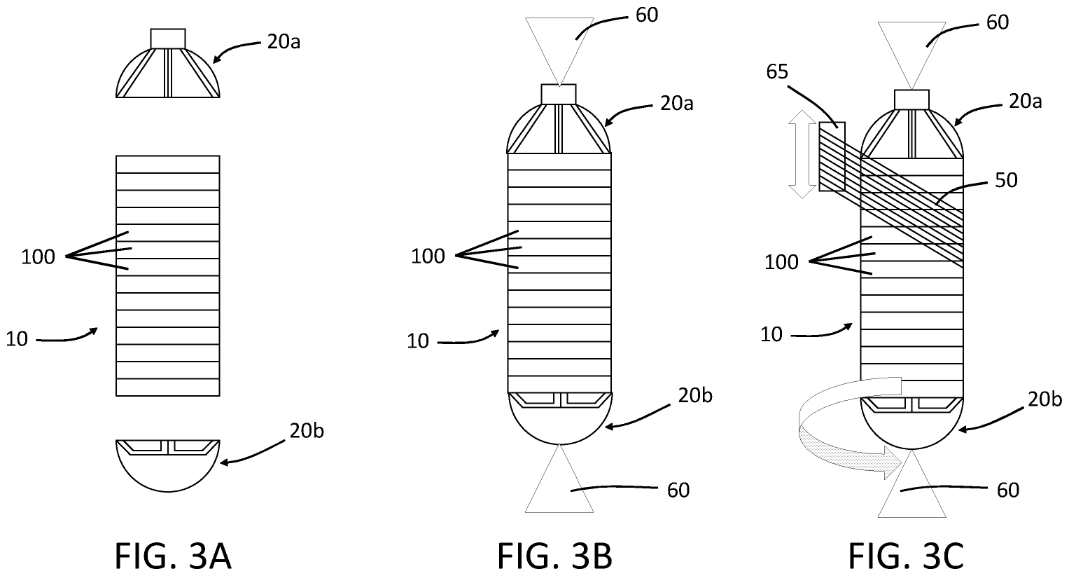

In the present embodiment, the longitudinal containment is provided by wrapping a fibre-reinforced material 50 around at least part of the stack 10 and at least a portion of each endcap 20a, 20b whereby to secure both of the endcaps 20a, 20b to the stack 10. It will be appreciated that the fibre-reinforced material 50 described herein may be used in combination with conventional bolted electrolyser units, but may also provide adequate containment by itself. The fibre-reinforced material 50 is preferably a composite material formed from a partially cured polymer matrix containing pre-impregnated fibres. The fibre may be carbon fibre, or may include different types of fibre such as glass fibre, or aramid fibre, or a combination of different fibres. A carbon-fibre reinforced material may be suitable for an electrochemical assembly 1 operating up to about 750 bar, for example. A glass-fibre reinforced material may be suitable for an electrochemical assembly 1 operating up to about 250 bar, for example. As will be described in more detail in relation to FIGS. 3A to 3C, the partially cured fibre-reinforced material 50 is flexible, and thus may be easily wrapped around the stack 10 and the endcaps 20a, 20b.

Optionally, a film or tape layer (not shown) may be wrapped around the stack 10 and/or the endcaps 20a, 20b as well as the fibre-reinforced material. The film or tape layer may be a gas impermeable layer to prevent leakage of hydrogen and/or a thermally insulating layer. A thermally insulating layer may be present when the electrochemical assembly 1 operated at high temperatures, such as for solid oxide electrolysis. The film or tape layer may be wrapped underneath the fibre-reinforced material 50. For example, the film or tape layer may comprise Kapton®.

As will later be described in more detail in relation to FIGS. 3A to 3C, once the partially cured fibre-reinforced material 50 is wrapped around the stack 10 and the endcaps 20a, 20b, it is fully cured using heat. For example, an autoclave may be used to heat the fibre-reinforced material 50 to a high temperature such as between 100 and 200 degrees, until it hardens to form a casing 50, preferably a rigid casing 50. The fibre-reinforced casing 50 thereby secures the endcaps 20a, 20b to the stack 10 such that a fluidic seal is formed between the stack 10 and each endcap 20a, 20b. The fibre-reinforced casing 50 has a much larger tensile strength than can be achieved using steel connections, and thus it is possible to operate the stack 10 at much higher pressures without any fluid leakage from between the layers 100 or between the stack 10 and the endcaps 20a, 20b. This means that the fluids can be supplied to the electrochemical assembly 1 at a required high pressure (rather than needing to pressurise the fluids within the electrochemical assembly 1, typically involving pressure differentials across the membrane which can be hard to achieve and may be a maximum of 30 bar). When used for electrolysis, output hydrogen may then also be output from the electrochemical assembly 1 at a relatively high pressure. The output hydrogen needs to be pressurised for compact storage, so directly producing high pressure hydrogen means that the external pressurizer can be made smaller or removed entirely. In conventional electrolyser units, the external pressurizer may contribute around 30% of the total cost. Indeed, facilitating high pressure supply of fluids to and from the electrochemical assembly 1 reduces the number of parts and the cost required to manufacture an electrochemical assembly 1. As noted above, when the electrochemical assembly 1 is capable of operating at high pressure, the input fluid (e.g. water) may be pressurized. The equipment required to pressurize the input water are much less expensive than the compressors otherwise required within an electrochemical assembly 1, including to pressurize the output hydrogen gas. Additionally, since water is an incompressible liquid, no P-V work is done during pressurization. This means that the overall process of producing hydrogen is much more energy efficient than processes that need to pressurize the output hydrogen.

In addition to the fluid containment discussed previously, it is advantageous to apply continuous longitudinal compression to the stack 10 during operation. This is to maintain good electrical contact between adjacent layers 100, and to prevent leakage of fluid from between the layers 100. In order to provide longitudinal compression of the stack 10, a resilient means 26 may be provided on one or both of the endcaps 20a, 20b. The resilient means 26 may be a resilient member such as a spring, or may be an elastomer, hydraulic piston, Belleville washer, or any combination of such resilient members. In the embodiment depicted in FIG. 2, a resilient means in the form of a spring 26 is located inside the first endcap 20a; the spring 26 presses between an interior surface of the endcap 20a and the stack 10 thereby providing a compressive force. As shown in FIG. 2D, the second endcap 20b has a rigid spacer 27 instead of a resilient means 26, but in other embodiments a resilient means such as a spring 26 may be located inside both endcaps 20a, 20b. Alternatively, no springs 26 may be used in either endcap 20a, 20b.

Preferably, the casing 50 extends fully around the stack 10 and substantially each of the first and second endcaps 20a, 20b. Preferably, the surface of the electrochemical assembly 1 is continuous between the stack 10 and the endcaps 20a, 20b; this ensures that the casing 50 is applied onto a continuous surface. The endcaps 20a, 20b may have a domed configuration, and preferably a hemi-spherical configuration. The casing 50 preferably extends over a domed portion of the endcaps 20a, 20b so that it may apply a force along the longitudinal axis thereby providing longitudinal containment.

An opening may be present in the casing 50 to facilitate connection to the fluid ports 24 and electrical contacts 28. If all of the fluid ports 24 and electrical contacts 28 are located on one of the endcaps 20a, 20b, then the other of the endcaps 20a, 20b may be fully covered by the casing 50. Preferably, there are no openings on the portion of the casing 50 that covers the stack 10.

A method for manufacturing the electrochemical assembly 1 of FIG. 2 will now be described in detail in relation to FIGS. 3A to 3C. FIG. 3A depicts the electrochemical stack 10 comprising a plurality of layers 100 (only some labelled), and the first and second endcaps 20a, 20b. At the stage of the process shown in FIG. 3A, the endcaps 20a, 20b are not secured to the stack 10.

In order to secure the endcaps 20a, 20b onto the stack 10, the endcaps 20a, 20b are mounted to a mandrel 60, as shown in FIG. 3B. The mandrel 60 provides longitudinal compression of the stack 10, and may at least partially compress the spring 26 (not shown) in either or both of the endcaps 20a, 20b. By compressing the stack 10 and the spring 26 with the mandrel 60, the layers 100 of the stack will remain tightly compressed together once the fibre-reinforced casing 50 is in place.

The fibre-reinforced material 50 is provided by a spool 65. The fibre-reinforced material 50 on the spool 65 is a partially cured polymer matrix containing pre-impregnated fibres. In this way, the partially cured material is flexible to facilitate wrapping of the stack 10 and the endcaps 20a, 20b. During the wrapping process, the stack 10 and the endcaps 20a, 20b are rotated by the mandrel 60, as shown in FIG. 3C. As the stack 10 and the endcaps 20a, 20b rotate, the spool 65 translates along the longitudinal axis next to the stack 10 and the endcaps 20a, 20b, such that the fibre-reinforced material 50 is progressively wrapped around the stack 10 and the endcaps 20a, 20b. The spool 65 may move in both directions along the longitudinal axis during ongoing wrapping until the layer of fibre-reinforced material 50 reaches a predetermined thickness. The spool 65 moves far enough along the longitudinal axis in both directions so that the fibre-reinforced material 50 covers at least a portion of each of the endcaps 20a, 20b. As already discussed above, an opening may be left in one or both of the endcaps 20a, 20b in order to facilitate connection to the fluid ports 24 and electrical contacts 28.

Subsequently, the mandrel 60 stops rotating and the spool 65 with any residual material 50 is removed. With the mandrel 60 (or other suitable device) still applying longitudinal compression to the stack 10, the fibre-reinforced material 50 is cured by heating it until it forms a casing 50, preferably a rigid casing 50. As discussed above, this may be achieved using an autoclave. The resulting electrochemical assembly 1 is removed from the mandrel 60 and can be used as an electrolyser or a fuel cell as described above.

The wrapping process described above may use equipment that is already readily available in the industry, such as for production of pressurized tanks. Therefore, the process does not require the development of additional manufacturing methods, and thus leads to an electrochemical assembly 1 that may be manufactured relatively cheaply. Additionally, since the fibre-reinforced casing 50 can withstand much higher longitudinal forces than conventional steel bolted electrolyser units, electrolysis and fuel cell operation can be performed at a much higher pressure. For electrolysis, this means that no additional pressurizer is required to pressurize the output hydrogen gas, which also reduces the cost of the electrochemical assembly 1.

An embodiment of an electrochemical stack 10 will now be described with reference to FIGS. 4 to 8. FIG. 4A is a simplified diagram of a typical stack 10′, with a plurality of layers 100 electrically connected in series, where each layer 100 comprises a single electrochemical cell 200. A limitation of this arrangement is that the size and shape of the cell 200 defines the size and shape of the layer 100 and therefore the size and shape of the stack 10. This means that the cells 200 must be fairly large so as to fill each layer 100, but this means that the regions nearer to the centre of the cell 200 do not receive as much fluid as regions near the edge of each cell 200. This decreases the efficiency of the cell 200 thereby reducing the efficiency of the stack 10 as a whole. Furthermore, since it is convenient to use square shaped cells 200 so that fluid inlets and outlets may be conveniently provided along the sides of the square. This means that the stack 10 depicted in FIG. 4A must be a cuboid to avoid wasting space near the edges of each layer 100.

FIG. 4B depicts an electrochemical stack 10 according to the present invention, where on each of the plurality of layers 100 that are electrically connected in series, there are plurality of cells 200. Each of the cells 200 has its own fluid inlets and outlets. Therefore, the stack 10 depicted in FIG. 4B solves the first problem identified above, since now fluid can more easily flow to and from the centre of each cell 200. Therefore, the cells 200 within each layer 100 are not fluidly connected to each other, but may nevertheless be connected to a common set of fluid ports through a manifold located at the ends of the stack. Preferably, each of the cells 200 on each layer 100 are electrically connected to each other in parallel. As will be described later in detail, this may be achieved by constructing the layers using conductive plates, thereby electrically connecting the cells 200 within each layer 100 in parallel.

Alternatively, the stack 10 may comprise a plurality of sub-stacks, with each sub-stack containing a plurality of layers each having one or more cells 200; the cells within a layer of each of the sub-stacks are neither fluidly nor electrically connected to each other. Note that the sub-stacks as a whole may be electrically connected in parallel by connecting the ends of the sub-stacks to a common pair of terminals. Though not described in detail, this may be achieved by constructing the layers with insulating plates with gaps where conductive plates may be inserted, thereby physically connecting but not electrically connecting or fluidly connecting the layers in adjacent sub-stacks.

FIG. 4C depicts another embodiment of a stack 10. This embodiment also comprises a plurality of cells 200 on each layer 100, but each layer 100 is circular so that the stack 10 as a whole is cylindrical. Since each layer 100 comprises a plurality of cells 200, the cells 200 still cover the majority of the layer 100 without wasting a significant amount of space. By decoupling the shape of the layer 100 from the shape of the cells 200, it is possible to construct a stack 10 in other shapes without wasting space that reduces efficiency. For example, it is desirable to have a cylindrical stack 10, since a cylinder shape is better able to withstand radial pressure from the pressurized fluids contained therein. Additionally, a cylindrical stack 10 can be more easily wrapped using the process described in relation to FIGS. 3A to 3C.

Each of the cells 200 may be very small in a similar style to the cells in a large battery, such as in an electric vehicle (EV). This approach may require a more complicated fluid management system in order to provide fluid inlets and fluid outlets to each of the cells 200 within each layer 100. It may be noted that in conventional stacks, the fluid inlets and fluid outlets are provided by etching or machining fluid channels in three dimensions within a solid nickel material. As nickel is a hard material, it is impractical to use this method to provide fluid inlets and fluid outlets to a plurality of cells in each layer due to the large number of fluid channels required. As will be described later, in the present embodiment, the cells 200 may be constructed using flat nickel plates and automated manufacturing, which allow for a simple way to provide fluid inlets and fluid outlets to each of the cells 200.

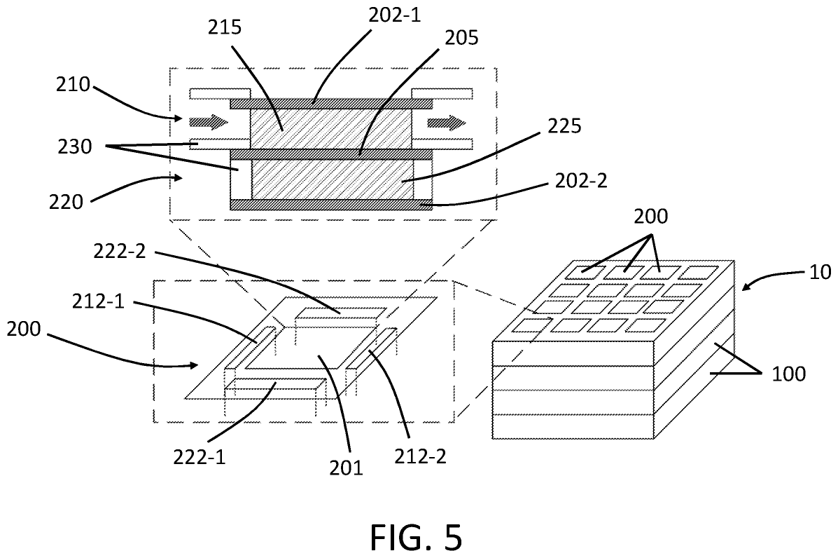

FIG. 5 shows the stack 10 depicted in FIG. 4B, an enlarged view of one of the cells 200, and a cross-section through a portion of one of the cells 200. In the enlarged view, the cell 200 comprises a square electrochemical region 201 that is surrounded by a plurality of inlet and outlet channels 212, 222. More specifically, a first fluid inlet channel 212-1 and a first fluid outlet channel 212-2 are arranged on a first pair of opposing sides of the electrochemical region 201. A second fluid inlet channel 222-1 and a second fluid outlet channel 222-2 are arranged on a second pair of opposing sides of the electrochemical region 201.

In this embodiment the first fluid inlet and fluid outlet channels 212 are arranged to supply fluid to and from the cathode 210, and the second fluid inlet and fluid outlet channels 222 are arranged to supply fluid to and from the anode 220, though it will be appreciated that these roles may be exchanged without affecting operation of the cell 200. By providing a corresponding pair of fluid inlet and fluid outlet channels 212, 222 on opposite sides of the electrochemical region 201, the fluid will flow across substantially the whole region 201. In particular, fluid moving between the first fluid inlet channel 212-1 and the first fluid outlet channel 212-2 will flow in a perpendicular direction to fluid moving between the second fluid inlet channel 222-1 and the second fluid outlet channel 222-2. Conversely, if corresponding pairs of fluid inlet and fluid outlet channels 212, 222 instead supplied fluid to adjacent sides of the electrochemical region 201, then there would be parts of the electrochemical region 201 that would have a poor fluid supply to/from the sets of fluid inlet and fluid outlet channels 212, 222.

The cross-section in FIG. 5 shows a first electrode 202-1 and a second electrode 202-2. In this embodiment the first and second electrodes 202 are configured as flat nickel bipolar plates that supply current for the electrolysis process, or provide current produced by a fuel cell process. Between the first electrode 202-1 and the second electrode 202-2 is provided a membrane 205. The membrane 205 conducts ions for the electrochemical reaction while preventing leakage of gas produced, thereby providing high purity products. The membrane 205 may be about 0.05 mm thick. Between the first electrode 202-1 and the membrane 205 is a first porous transport layer 215. Between the second electrode 202-2 and the membrane 205 is a second porous transport layer 225. The porous transport layers 215, 225 comprise nickel felt or nickel foam that conducts current for the electrochemical reaction while permitting flow of water and gas through the cell 200. The nickel foam may be less than 2 mm thick, and may be about 0.5 mm to 1 mm thick.

As depicted, fluid flows from left to right through the first porous transport layer 215; fluid flows through the second porous transport layer 225 in a perpendicular direction into the page. However, the direction of fluid flow through either or both of the first and second fluid transport layers 215, 225 may be reversed without affecting operation of the cell 200. In other words, the fluid inlet channels 212-1, 222-1 may be exchanged with the fluid outlet channels 212-2, 222-2 without affecting operation of the cell 200.

Each of the cells 200 within each layer 100 is arranged as described above. This means that each layer 100 is connected to a plurality of fluid inlet and fluid outlet channels 212, 222, where each cell 200 within each layer 100 is supplied by a separate subset of the fluid inlet and fluid outlet channels 212, 222. In other words, each of the cells 200 within each layer 100 are not fluidly connected. In this embodiment, each cell 200 comprises two pairs of fluid inlet and fluid outlet channels 212, 222, but more or fewer fluid channels 212, 222, may be provided to each cell 200. Additionally, the inlet and outlet channels 212, 222 extend through a longitudinal length of the stack 10, such that adjacent cells 200 within adjacent layers 100 are supplied by the same subset of fluid inlet and fluid outlet channels 212, 222.

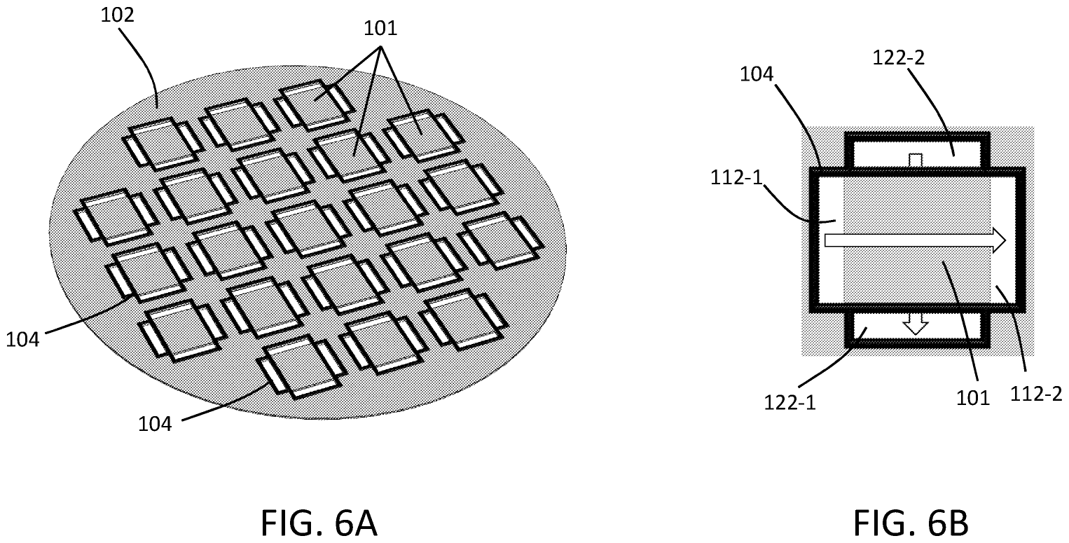

Each cell 200 may be supported by a moulded plastic frame 230, which spaces the electrodes 202 from the membrane 205 and contains the cell elements such as the porous transport layers 215, 225. For example, a nickel shim may be inserted into the plastic frame 230 in order to provide the bipolar plates that form the electrodes 202-1, 202-2. Advantageously, this allows the cells 200 and layers 100 to be manufactured from relatively cheap materials. An alternative implementation of a stack 10 will be described further in relation to FIGS. 6 to 8.

While only one cell 200 is shown in the cross section in FIG. 5, the first electrode 202-1 for each of the cells 200 in a layer 100 may be formed from a single plate. Likewise, the second electrode 202-2 for each of the cells 200 in a layer 100 may also be formed from a single plate. In this way, all of the cells 200 within a layer 100 are electrically connected in parallel but are not fluidly connected to each other. By using plates to provide all the cells 200 within each layer 100, the resulting stack 10 is rigid and may be easily manufactured and assembled. Furthermore, using nickel plates rather than machining three-dimensional channels in a solid nickel, the overall amount of nickel is reduced, which decreases the cost of the stack 10. Since multiple layers 100 are used to form the stack 10, the first electrode 202-1 of one layer 100 may simultaneously provide the second electrode 202-2 of an adjacent layer 100. Therefore, as used herein the term “layer” does not require that elements in a particular layer 100 cannot also form part of a different layer 100.

Referring now to FIGS. 6 to 8, a particularly advantageous embodiment of the invention will now be described. FIG. 6A depicts a plate 102 that may be used to construct a layer 100 of the stack 10. In this example, the plate 102 is circular with a diameter of about 300 mm, but the plate 102 may have other shapes and may have different dimensions. The plate 102 has a number of defined regions 101 that each provide the electrochemical regions 201 of the plurality of cells 200 in the stack 10. In this example, the plate 102 has 21 regions 101 thereby providing 21 cells 200 in each layer 100, but any other number of regions 101 may be used. Additionally, the regions 101 may have different sizes to provide cells 200 with different sizes. Preferably, the regions 101 are arranged in a grid. The plate 102 also has a plurality of apertures 112, 122 that provide the inlet and outlet channels 212, 222 of the stack 10. More specifically, the first fluid inlet channel 212-1 and the first fluid outlet channel 212-2 are provided by a first pair of apertures 112-1, 112-2. The second fluid inlet channel 222-1 and the second fluid outlet channel 222-2 are provided by a second pair of apertures 122-1, 122-2. Alternatively, more or fewer apertures 112, 122 may be provided in order to provide more or few channels 212, 222. In this example, each aperture 112, 122 is a rectangular elongate slot about 25 mm long, and 5 mm wide, though other shapes and dimensions may be used depending on the size of the regions 101 and the size of the plate 102.

A gasket structure 104 is arranged on both sides of the plate 102 in order to constrain the flow of fluid between the apertures 112, 122. As particularly shown using the arrows in FIG. 6B, the gasket structure 104 causes fluid to flow between the first pair of apertures 112-1, 112-2 on one side of the plate 102, and causes fluid to flow between the second pair of apertures 122-1, 122-2 on an opposite side of the plate 102. To do so, the gasket structure 104 on one side of the plate 102 is in an orthogonal direction to the gasket structure 104 on the opposite side of the plate 102. As shown in FIG. 6A, there is a corresponding gasket structure 104 present for each of the regions 101. The gasket structure 104 may be applied to the plate 102 or may be moulded onto the plate 102 before assembly of the plates 102 to form the stack 10. The gasket structure 104 is made of a material that is resistant and impermeable to gaseous oxygen and hydrogen, and liquid potassium hydroxide (KOH). For example, the material may be a perfluoroelastomer such as FKM.

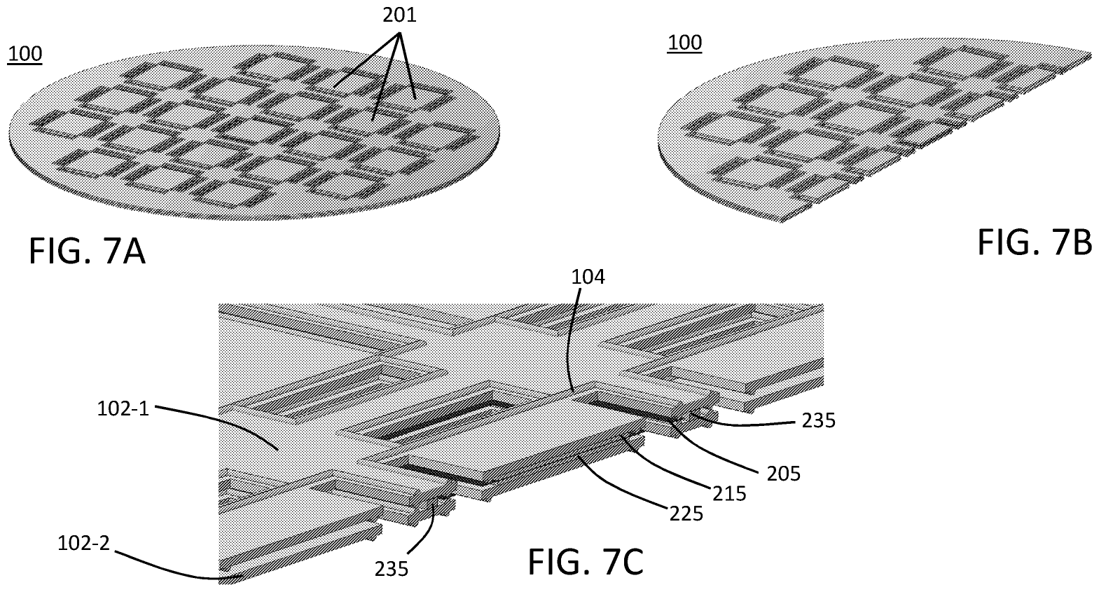

FIG. 7A depicts a layer 100 formed from a combination of a first plate 102-1 and a second plate 102-2. FIG. 7B shows a cross-section through the layer 100 and FIG. 7C shows a close-up of the cross-section shown in FIG. 7B. Each of the defined regions 101-1 of the first plate 102-1 are aligned with each of the defined regions 101-2 of the second plate 102-2, thereby providing the plurality of electrochemical regions 201 of the plurality of cells 200. Between the defined regions 101-1, 101-2 of each plate 102-1, 102-2 is provided a membrane 205 such as the membrane 205 described previously. Between the first plate 102-1 and the membrane 205 is a first porous transport layer 215. Between the second plate 102-2 and the membrane 205 is a second porous transport layer 225. In this embodiment, the membrane 205 and the porous transport layers 215, 225 are separate elements individually placed between the regions 101-1, 101-2 of the plates 102 during assembly. Alternatively, the membrane 205 and/or the porous transport layers 215, 225 may be substantially the same size as the plates 102-1, 102-2 and may have corresponding apertures that align with the apertures 112, 122 in the plates 102-1, 102-2.

A frame or spacer 235 may be located between the plates 102-1, 102-2 in order to control compression of the gasket structure 104. The frame 235 may be a polymer frame 235 and may be located between the plates 102-1, 102-2 in areas which are not occupied by the electrochemical regions 201 or apertures 112, 212. In the example shown in FIG. 7C, the frame 235 is located between the gasket structures 104 corresponding to adjacent cells 200 in the layer 100. Preferably, the frame 235 that is used to separate the plates 102-1, 102-2 is a single element so that the frame 235 may be easily located between the plates 102-1, 102-2 during assembly of the stack 10. The frame 235 is preferably electrically insulating and may have a thickness that is between about 0.1 mm to about 25 mm.

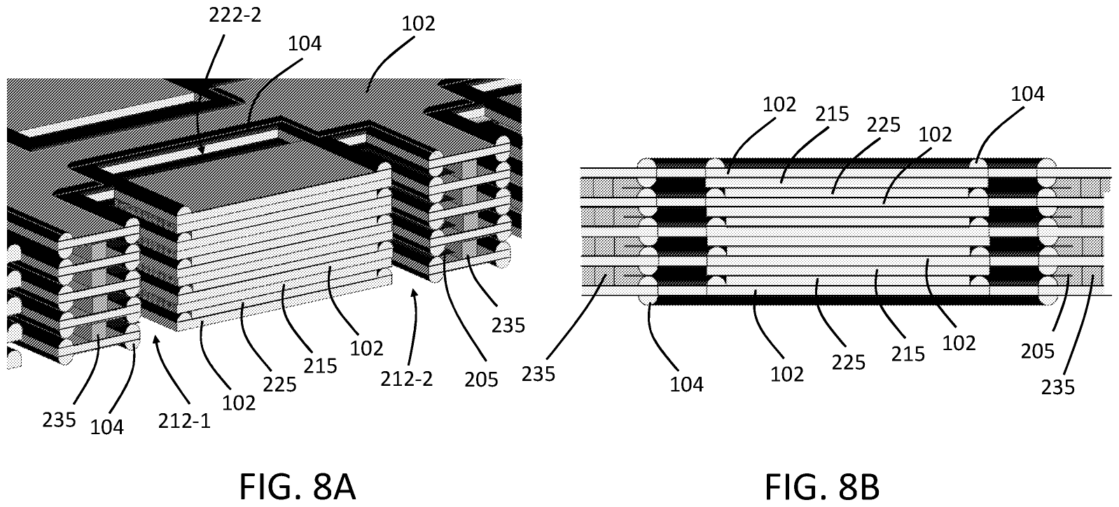

While FIGS. 7A to 7C only depict two plates 102-1, 102-2 that form one layer 100, a large number of plates 102 may be aligned adjacent to each other with membranes 205, porous transport layers 215, 225, and frames 230 located therebetween, in order to provide a stack 10 with a plurality of layers 100. This is shown particularly with respect to FIGS. 8A and 8B, which show cross-sections through part of a stack 10 with five plates 102 forming four layers 100. Only some of the components forming each of the layers 100 are labelled, for clarity purposes. While this example only has four layers 100, a stack 10 may have many more layers 100, and may have thousands of layers 100.

Once the plates 102 are aligned, the apertures 112, 122 in each of the plates align to provide channels 212, 222 through a longitudinal length of the stack 10. Fluid is supplied to each of these channels with fluid distribution layers 25 in a manifold 22 arranged at either or both ends of the stack 10, such as those fluid distribution layers 25 and manifolds 22 discussed earlier in relation to FIGS. 2A to 2C. During an electrolysis operation, a power supply 5 will apply a voltage to opposite ends of the stack 10; since the layers 100 are arranged in series, each of the plates 102 in the stack may simultaneously provide the cathode 210 for one layer 100 and the anode 220 for an adjacent layer 100. During a fuel cell operation, the opposite ends of the stack 10 will instead apply a voltage to an external load.

It will be appreciated that the arrangement described above may substantially simplify the manufacture and assembly of the stack 10. As noted before, conventional stacks are manufactured by etching or machining three-dimensional channels into a nickel material, before being assembled with other components to form the stack 10. However, this process is not easily adapted to be performed automatically so that the stacks may be produced in bulk. In contrast to this, the plates 102 described above can be easily produced in a single stamping process to create the apertures 112, 122 and to arrange the gasket structures 104 on the plate 102. Subsequently, the plates 102, together with membranes 205, transport layers 215, 225, and frames 235 may be layered to form a stack 10 with all the required fluid channels that provide the fluid inlets and outlets to all the cells 200 in all the layers 100. The stamping, arrangement and layering may be performed autonomously such as on a production line. The assembly of each stack 10 with endcaps 20 and casing 50 may also be performed autonomously such as on a production line. In this way, large numbers of electrochemical assemblies 1 may be manufactured quickly and cheaply.

The resulting stack 10 may form part of the electrochemical assembly 1 described earlier in relation to FIGS. 2 and 3, where endcaps 20a, 20b provide the fluid ports 24 and fluid distribution manifolds 22 for supplying fluid to and from the stack 10. It will be appreciated that the stack 10 described in relation to FIGS. 4 to 8 may be used in other electrochemical units. Similarly, the electrochemical assembly 1 described in relation to FIGS. 2 and 3 may use any configuration of stack, including stacks that do not have a plurality of cells on each layer. However, it may be particularly advantageous to use the stack 10 in the electrochemical assembly 1, since the stack 10 may be constructed as a cylinder, which may more readily be wrapped in a fibre-reinforced material 50 to form a casing 50.

While the foregoing is directed to exemplary embodiments of the present invention, it will be understood that the present invention is described herein purely by way of example, and modifications of detail can be made within the scope of the invention. Furthermore, one skilled in the art will understand that present invention may not be limited to the embodiments disclosed herein, or to any details shown in the accompanying figures that are not described in detail herein or defined in the claims. Indeed, such superfluous features may be removed from the figures without prejudice to the present invention. It will also be appreciated that particular combinations of the various features described and defined in any aspects described herein can be implemented and/or supplied and/or used independently. Any apparatus feature described herein may also be incorporated as a method feature, and vice versa.

Moreover, other and further embodiments of the invention will be apparent to those skilled in the art from consideration of the specification, and may be devised without departing from the basic scope thereof, which is determined by the claims that follow.

1. An electrochemical assembly, comprising:
a plurality of electrochemical cells arranged to form an electrochemical stack having a first end and a second end;
a first endcap disposed at the first end of the electrochemical stack, and a second endcap disposed at the second end of the electrochemical stack, and at least one of the endcaps being arranged to provide a fluidic connection to the electrochemical stack;
wherein the first and second endcaps are secured to the electrochemical stack by a fibre-reinforced casing that extends around at least a portion of the electrochemical stack and at least a portion of each endcap such that a fluidic seal is formed between the electrochemical stack and each endcap.

2. The electrochemical assembly of claim 1, wherein the fibre-reinforced casing is a unitary casing.

3. The electrochemical assembly of claim 1, wherein the casing is arranged to surround substantially all of the electrochemical stack and substantially all of each endcap.

4. The electrochemical assembly of claim 1, wherein the first and second endcaps are configured as fluid distribution manifolds for facilitating internal fluid flow through the electrochemical stack.

5. The electrochemical assembly of claim 1, wherein at least one of the endcaps comprises one or more fluid ports arranged to transmit fluid therethrough, thereby to provide a fluid connection to the electrochemical stack.

6. The electrochemical assembly of claim 1, wherein at least one of the endcaps is configured to provide at least one electrical connection to the electrochemical stack.

7. The electrochemical assembly of claim 1, wherein at least one of the endcaps comprises a compression device arranged to apply a compressive force to the plurality of electrochemical cells forming the electrochemical stack when secured thereto, with the compressive force being applied in a longitudinal direction between the endcaps.

8. The electrochemical assembly of claim 7, wherein the force applied by the compression device is adjustable.

9. The electrochemical assembly of claim 1, wherein the electrochemical stack comprises:
a plurality of layers, each layer electrically connected with an adjacent layer;
wherein each layer comprises a plurality of electrochemical cells.

10. (canceled)

11. The electrochemical assembly of claim 9, wherein at least one of:
adjacent layers in the electrochemical stack are electrically connected to each other in series, or
the plurality of electrochemical cells in each layer are electrically connected together in parallel.

12-14. (canceled)

15. The electrochemical assembly of claim 9, wherein the plurality of layers are further configured to provide a plurality of fluid inlet channels and a plurality of fluid outlet channels within the electrochemical stack, the inlet channels and outlet channels arranged to transmit fluid to and from each layer of the electrochemical stack, whereby and further to transmit fluid across each electrochemical cell in each layer.

16. The electrochemical assembly of claim 15, wherein each electrochemical cell within each layer of the electrochemical stack is arranged to have fluid transmitted across it via at least one fluid inlet channel and at least one fluid outlet channel that together form a subset of the plurality of fluid inlet channels and fluid outlet channels that are arranged to transmit fluid to and from that layer.

17. The electrochemical assembly of claim 15, wherein the plurality of fluid inlet channels and fluid outlet channels are arranged to extend between the endcaps through the electrochemical stack, such that adjacent electrochemical cells within adjacent layers of the electrochemical stack are supplied by the same subset of fluid inlet channels and fluid outlet channels.

18. The electrochemical assembly of claim 15, wherein each subset of fluid inlet channels and fluid outlet channels comprises:
a first fluid inlet channel and a first fluid outlet channel together arranged to transmit fluid across one or more electrochemical cells in a first direction; and
a second fluid inlet channel and a second fluid outlet channel together arranged to transmit fluid across one or more of the electrochemical cells in a second direction, which is different to the first direction.

19. The electrochemical assembly of claim 9, wherein each layer of the electrochemical stack comprises:
a first plate and a second plate arranged in an opposed configuration, each plate providing a respective electrode for each of the plurality of electrochemical cells on the layer;
a partially-permeable membrane for the transmission of ions disposed between the first plate and the second plate;
a first porous transport layer, arranged to allow a first fluid to flow in a first direction, disposed between the first plate and the membrane; and
a second porous transport layer, arranged to allowing a second fluid to flow in a second direction, disposed between the second plate and the membrane.

20. (canceled)

21. The electrochemical assembly of claim 1, wherein the electrochemical stack is substantially cylindrical.

22. The electrochemical assembly of claim 1, wherein the electrochemical assembly is configured as an electrolyser assembly.

23. The electrochemical assembly of claim 1, wherein the electrochemical assembly is configured as a fuel cell.

24-27. (canceled)

28. A method of manufacturing an electrochemical assembly, comprising:
arranging a plurality of layers of electrochemical cells to form an electrochemical stack having a first end and a second end;
positioning a first endcap at the first end of the stack, and a second endcap at the second end of the stack, with at least one of the first or second endcaps being arranged to provide a fluidic connection to the electrochemical stack;
wrapping a fibre-reinforced material around the electrochemical stack to form a layer that covers at least a portion of the electrochemical stack and at least a portion of each endcap whereby to secure both of the endcaps to the stack such that the endcaps are fluidly sealed with the electrochemical stack; and
curing the fibre-reinforced material through the application of heat to form a fibre-reinforced casing.

29. The method of claim 28, wherein wrapping the fibre-reinforced material around the electrochemical stack and endcaps is performed by mounting them to a rotatable mandrel configured to apply a compressive force to the plurality of electrochemical cells forming the electrochemical stack during wrapping.
